(19) United States
(12) Patent Application Publication
(10) Pub. No.: US 2024/0180383 A1
(43) Pub. Date: Jun. 6, 2024

(54) LIFELONG ROBOT LEARNING FOR MOBILE ROBOTS

(71) Applicant: Robert Bosch GmbH, Stuttgart (DE)

(72) Inventors: Katsu Yamane, Mountain View, CA (US); Sharath Gopal, Fremont, CA (US); Liu Ren, Saratoga, CA (US); Alexander Kleiner, Neuhausen (DE); Robert Schirmer, Schoemberg (DE)

(21) Appl. No.: 18/062,300

(22) Filed: Dec. 6, 2022

(51) Int. Cl. A47L 11/40; G05D 1/00; G05D 1/02

(52) U.S. Cl. CPC A47L 11/4011; G05D 1/0044; G05D 1/0214; G05D 1/0274; A47L 2201/04; G05D 2201/0215

(57) ABSTRACT

A method is disclosed for improving a mobile robot that is configured to perform a task in an environment using an operating procedure. Data is received that was recorded by the mobile robot using one or more sensors as the mobile robot navigates the environment to perform the task. A database and/or a model associated with the environment is updated to incorporate the recorded data. The operating procedure of the mobile robot can be modified, based on the database and/or the model, to generate a modified operating procedure for performing the task in the environment that improves a performance of the mobile robot. Additionally, a recommendation for improving the performance of the mobile robot when performing the task in the environment can be determined, based on the database and/or the model, and displayed to a user for consideration.

### FIELD

The device and method disclosed in this document relates to mobile service robots and, more particularly, to lifelong robot learning for mobile service robots.

### BACKGROUND

Unless otherwise indicated herein, the materials described in this section are not admitted to be the prior art by inclusion in this section.

In current robot vacuum products, their associated smartphone apps can show the cleaned area within the home or a trajectory of the vacuum robot during the last cleaning mission within the home. These robot vacuums can also detect different objects using images from an onboard camera. However, these robot vacuums do not use the trajectory data from previous cleaning missions to improve performance or efficiency for future cleaning missions and do not associate camera images with the trajectories or other sensor data.

In lifelong learning research for robot vacuums, techniques have been developed for creating consistent semantic maps from different missions and improving navigation performance using experience from previous missions. In some methodologies, a surface area is divided semantically into cluttered and non-cluttered regions and a coverage pattern is planned that covers these regions sequentially. However, these techniques improve the performance by changing the behavior of the robot vacuum while keeping the environment same.

### SUMMARY

A method for operating a mobile robot system is described. The mobile robot system includes a mobile robot configured to perform a task in an environment using an operating procedure. The method comprises receiving first data that was recorded by the mobile robot at least in part using at least one sensor as the mobile robot navigates the environment to perform the task. The method further comprises updating at least one of a database and a model associated with the environment to incorporate the first data. The method further comprises at least one of (1) modifying the operating procedure, based on the at least one of the database and the model, to generate a modified operating procedure for performing the task in the environment that improves a performance of the mobile robot, and (2) determining, based on the at least one of the database and the model, and causing to be displayed to a user, a recommendation for improving the performance of the mobile robot when performing the task in the environment.

Another method for operating a mobile robot system is described. The mobile robot system includes a mobile robot configured to perform a task in an environment using an operating procedure. The method comprises receiving first data that was recorded by the mobile robot at least in part using at least one sensor as the mobile robot navigates the environment to perform the task. The method further comprises updating at least one of a database and a model associated with the environment to incorporate the first data. The method further comprises modifying the operating procedure, based on the at least one of the database and the model, to generate a modified operating procedure for performing the task in the environment that improves a performance of the mobile robot. The method further comprises providing the modified operating procedure to the mobile robot, the mobile robot being configured to perform the task in the environment again using the modified operating procedure.

Yet another method for operating a mobile robot system is described. The mobile robot system includes a mobile robot configured to perform a task in an environment using an operating procedure. The method comprises receiving first data that was recorded by the mobile robot at least in part using at least one sensor as the mobile robot navigates the environment to perform the task. The method further comprises updating at least one of a database and a model associated with the environment to incorporate the first data. The method further comprises determining, based on the at least one of the database and the model, and causing to be displayed to a user, a recommendation for improving a performance of the mobile robot when performing the task in the environment.

### BRIEF DESCRIPTION OF THE DRAWINGS

The foregoing aspects and other features of the methods are explained in the following description, taken in connection with the accompanying drawings.

FIG. 1 shows a mobile robot system.

FIG. 2A shows an exemplary embodiment of a mobile robot of the mobile robot system.

FIG. 2B shows an exemplary embodiment of a cloud backend of the mobile robot system.

FIG. 2C shows an exemplary embodiment of a personal electronic device of the mobile robot system.

FIG. 3 shows flow diagram for a method for improving performance and efficiency of a mobile robot that navigates an environment to perform a task.

FIG. 4A shows a simple histogram model that indicates a relative proportion or amount of time spent by the mobile robot at various positions or regions within the environment 40 while performing the task.

FIGS. 4B-4C show Gaussian mixture models that indicate a relative proportion or amount of time spent by the mobile robot at various positions or regions within the environment while performing the task.

FIGS. 4D-4F show mean shift clustering models that indicate a relative proportion or amount of time spent by the mobile robot at various positions or regions within the environment while performing the task.

FIG. 5 shows illustrates an exemplary revised trajectory superimposed onto an environment map that includes a “no-go” zone.

FIG. 6 shows a plurality of possible base station locations superimposed onto an environment map.

### DETAILED DESCRIPTION

For the purposes of promoting an understanding of the principles of the disclosure, reference will now be made to the embodiments illustrated in the drawings and described in the following written specification. It is understood that no limitation to the scope of the disclosure is thereby intended. It is further understood that the present disclosure includes any alterations and modifications to the illustrated embodiments and includes further applications of the principles of the disclosure as would normally occur to one skilled in the art which this disclosure pertains.

### Overview

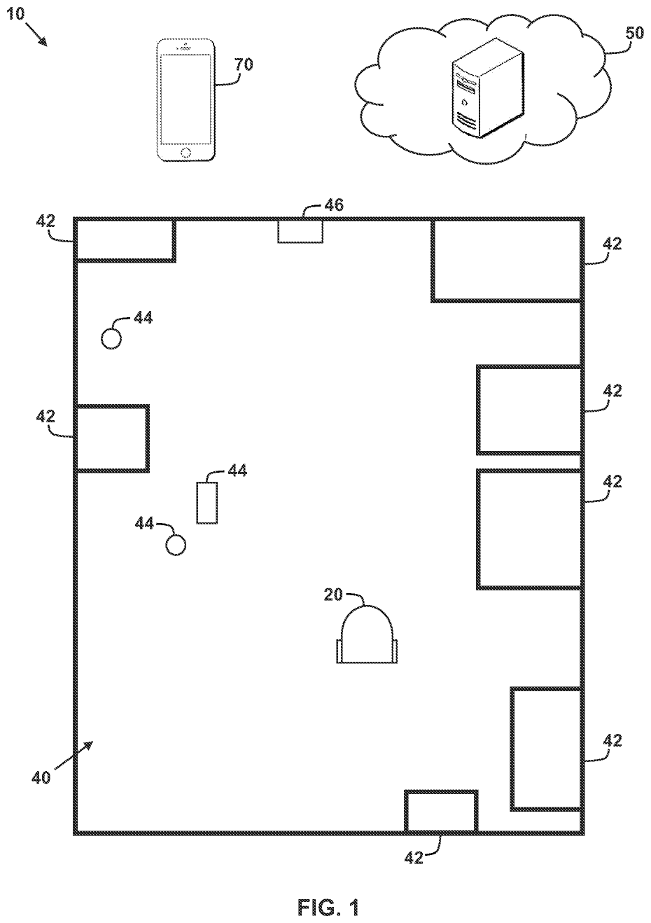

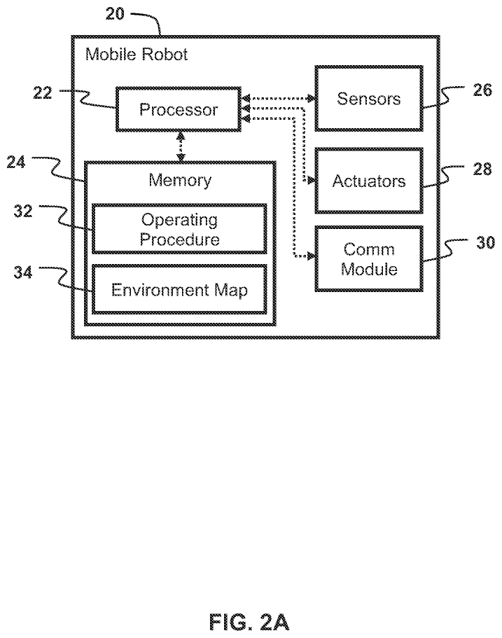

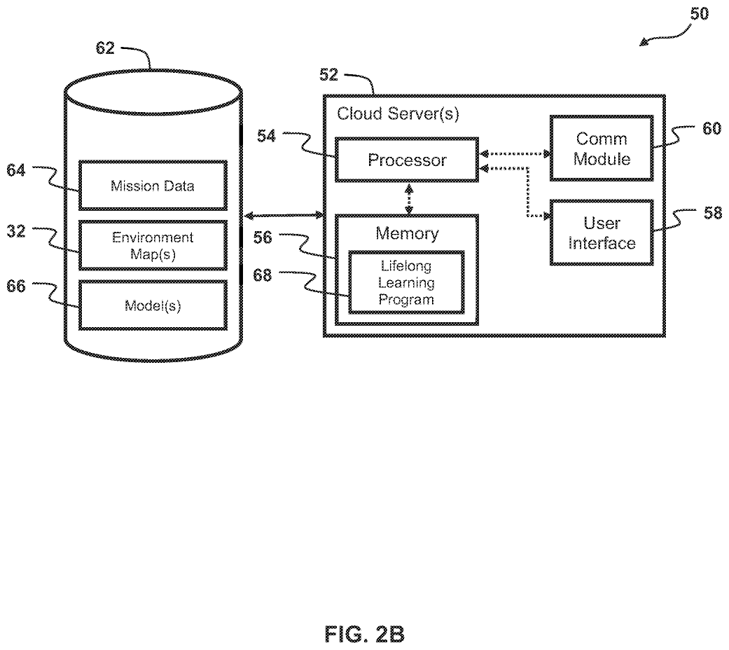

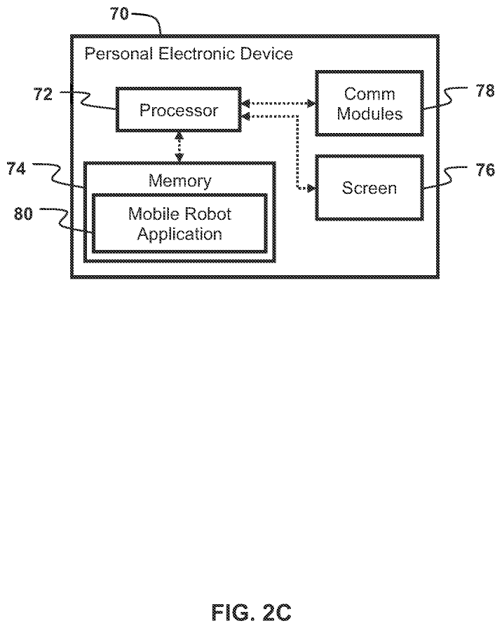

With reference to FIGS. 1 and 2A-2C, a mobile robot system 10 is described that includes at least one mobile robot 20 configured to perform a task in an environment 40 using an operating procedure (e.g., on-board software and algorithms). In the embodiments described in detail herein, the mobile robot 20 is, in particular, a robot vacuum or a robot mop that is configured to navigate the environment 40 to clean a floor surface in the environment 40. However, it should be appreciated by those of ordinary skill that the systems and methods described herein may be applicable to a wide variety of mobile robots that autonomously navigate an environment to perform some task.

The mobile robot system 10 advantageously leverages lifelong learning to improve performance and efficiency of the mobile robot 20 over time as it performs the task in the environment. Particularly, over time, the mobile robot 20 may perform the task in the same environment 40 many times. Each performance of the task may be referred to herein as a “mission.” During each mission, the mobile robot 20 records and accumulates data including trajectory data, image data, and event data (e.g., mission failure or collision events), generally in the form of time series data in which the data is timestamped. The trajectory and image data will be different for every mission even in the same environment due to different starting locations, temporary clutter in the environment 40, humans and pets moving around the environment 40, open/closed doors in the environment 40, and sensing noise. By accumulating data from multiple missions, outlier and erroneous data can be identified and ignored if appropriate.

The mobile robot system 10 extracts useful information from the accumulated data that can be used to help improve a performance or efficiency of the mobile robot 20 during future mission in the environment 40. In some embodiments, one or more models are applied to or trained from the accumulated data for the purpose of abstracting the data so that it is easier for the mobile robot 20 to process or for users to understand. As new data is collected, the models are further refined.

Using the extracted information, the mobile robot system 10 can automatically modify the operating procedure of the mobile robot 20 for the particular environment 40 or make recommendations to the user of modifications the operating procedure or of changes that the user can make to the environment 40 that would improve the performance or efficiency of the mobile robot 20 for future missions in the environment.

In some embodiments, based on the extracted information, the mobile robot system 10 recommends setting or automatically sets “no-go” zones within the environment 40 that should be avoided by the mobile robot 20 during future missions to improve its performance or efficiency. For example, in the illustration of FIG. 1, the environment 40 includes various obstacles 42, such as furniture, which cause certain regions to be inaccessible to the mobile robot or which are only partially accessible and may trap the mobile robot 20. These regions can be advantageously marked as “no-go” zones and simply avoided by the mobile robot 20.

In some embodiments, based on the extracted information, the mobile robot system 10 recommends adjusting or automatically adjusts a trajectory planning or region prioritization such that certain problematic regions of within the environment 40 are visited last during future missions to improve its performance or efficiency. For example, if the mobile robot 20 is a robot vacuum or the like, there may be regions within the environment 40 that are difficult to clean, such an entrance to the environment 40 having a dirty doormat or which is frequently filled with clutter 44 or debris, such as shoes. It may be preferable for the robot vacuum to clean the rest of environment 40 first before cleaning the entrance area to ensure that the robot vacuum has sufficient battery to clean the entire environment, before spending excessive time at the entrance area.

In some embodiments, based on the extracted information, the mobile robot system 10 identifies a problematic object and recommends modifying or automatically modifies the operating procedure of the mobile robot 20 so that the mobile robot 20 avoids the object or similar objects during future missions to improve its performance or efficiency. For example, in the illustration of FIG. 1, the environment 40 includes clutter 44 on the floor of the environment. The clutter 44 may be small objects, such as shoes or electrical cords, that are easily pushed around or driven over by the mobile robot 20, but which are likely to cause the mobile robot 20 to become stuck (e.g., because a shoe lace or electrical cord becomes tangled with a wheel of the mobile robot 20).

In some embodiments, based on the extracted information, the mobile robot system 10 identifies an object within the environment 40 and recommends that the user remove the identified object from the environment 40 before performing future missions to improve the performance or efficiency of the mobile robot 20. These identified objects may, for example, include the clutter 44 or other problematic objects within the environment 40.

In some embodiments, based on the extracted information, the mobile robot system 10 identifies a new location for a base station 46 for the mobile robot 20 and recommends that the user move the base station 46 to the new location to improve the performance or efficiency of the mobile robot 20. The new location may, for example, reduce an average travel time or distance required by the mobile robot 20 to perform the task in the environment 40.

With continued reference to FIG. 1, in at least some embodiments, the mobile robot system 10 further includes a cloud backend 50. Particularly, the cloud backend 50 may be configured to store the accumulated data that is collected by the mobile robot 20. Likewise, the cloud backend 50 may be configured to extract the information from the accumulated data and to determine the modifications to be made to the operating procedures of the mobile robot 20 or determine the recommendations to be made to the user, which were discussed above. However, it should be appreciated that these functions can likewise be completed locally using the mobile robot 20 itself.

In at least some embodiments, the mobile robot system 10 further includes a personal electronic device 70, such as a mobile phone or tablet computer, via which a user can manage and operate the mobile robot 20. The recommendations discussed above can be presented to the user via an associated application on the personal electronic device. Such an application might also be used to operate and configure the mobile robot 20. However, it should be appreciated that these functions can likewise be completed locally using the mobile robot 20 itself, such as using a user interface integrated with the mobile robot 20.

### Mobile Robot

FIG. 2A shows an exemplary embodiment of the mobile robot 20. In the illustrated embodiment, the mobile robot 20 comprises, for example, a processor 22, a memory 24, one or more sensors 26, one or more actuators 28, and at least one network communication module 30. It will be appreciated that the illustrated embodiment of the mobile robot 20 is only one exemplary embodiment is merely representative of any of various manners or configurations of mobile robots that autonomously navigate an environment to perform some task.

The processor 22 is configured to execute instructions to operate the mobile robot 20 to enable the features, functionality, characteristics and/or the like as described herein. To this end, the processor 22 is operably connected to the memory 24, the one or more sensors 26, and the one or more actuators 28. The processor 22 generally comprises one or more processors which may operate in parallel or otherwise in concert with one another. It will be recognized by those of ordinary skill in the art that a “processor” includes any hardware system, hardware mechanism or hardware component that processes data, signals or other information. Accordingly, the processor 22 may include a system with a central processing unit, graphics processing units, multiple processing units, dedicated circuitry for achieving functionality, programmable logic, or other processing systems.

The memory 24 is configured to store data and program instructions that, when executed by the processor 22, enable the mobile robot 20 to perform various operations described herein. The memory 24 may be of any type of device capable of storing information accessible by the processor 22, such as a memory card, ROM, RAM, hard drives, discs, flash memory, or any of various other computer-readable medium serving as data storage devices, as will be recognized by those of ordinary skill in the art. As discussed in further detail below, the processor 22 is configured to execute program instructions of an operating procedure 32, which is stored in the memory 24, to navigate the environment 40 to perform a task, such as cleaning floor surface in the environment 40. In at least one embodiment, the operating procedure 32 utilizes an environment map 34 that virtually represents the environment 40 to aid in performing the task.

The one or more sensors 26 may comprise a variety of different sensors. In some embodiments, the sensors 26 include sensors configured to measure one or more accelerations, rotational rates, and/or orientations of the mobile robot 20. In one embodiment, the sensors 26 include one or more accelerometers configured to measure linear accelerations of the mobile robot 20 along one or more axes (e.g., roll, pitch, and yaw axes), or more gyroscopes configured to measure rotational rates of the mobile robot 20 along one or more axes (e.g., roll, pitch, and yaw axes), and/or an inertial measurement unit configured to measure all of the above.

In some embodiments, the sensors 26 include one or more cameras configured to capture a plurality of images of the environment 40 as mobile robot 20 navigates through the environment 40. The camera(s) generate image frames of the environment 40, each of which comprises a two-dimensional array of pixels. Each pixel has corresponding photometric information (intensity, color, and/or brightness). In some embodiments, the camera(s) are configured to generate RGB-D images in which each pixel has corresponding photometric information and geometric information (depth and/or distance). In such embodiments, the camera(s) may, for example, take the form of two RGB cameras configured to capture stereoscopic images, from which depth and/or distance information can be derived, or an RGB camera with an associated IR camera configured to provide depth and/or distance information.

In some embodiments, the sensors 26 include a light sensor (e.g., LiDAR or any other time of flight or structured light based sensor), configured to emit measurement light (e.g., lasers) and receive the measurement light after it has reflected throughout the environment 40. In time-of-flight based embodiments, the processor 22 is configured to calculate times of flight and/or return times for the measurement light. Based on the calculated times of flight and/or return times, the processor 22 may for example generate the environment map 34 in the form of a point cloud or raster map. In structured light based embodiments, the processor 22 applies an algorithm to extract a 3D profile of surfaces onto which the structured light is projected (e.g., based on a fringe pattern generated on a surface).

The one or more actuators 28 at least include motors of a locomotion system that, for example, drive a set of wheels to cause the mobile robot 20 to move throughout the environment 40 to perform the task. Additionally, in some embodiments, the one or more actuators 28 at least include a vacuum suction system configured to vacuum a floor surface as the mobile robot 20 navigates through the environment 40. Mobile robots 20 that perform other tasks in the environment may, of course, different types of actuators 28 that are suitable to other tasks.

The network communications module 30 may comprise one or more transceivers, modems, processors, memories, oscillators, antennas, or other hardware conventionally included in a communications module to enable communications with various other devices, at least including the cloud backend 50 and/or the personal electronic device 70. Particularly, the network communications module 30 generally includes a Wi-Fi module configured to enable communication with a Wi-Fi network and/or Wi-Fi router (not shown), as well as one or more cellular modems configured to communicate with wireless telephony networks. Additionally, the network communications module 30 may include a Bluetooth® module (not shown) configured to enable communication with the personal electronic device 70.

The mobile robot 20 may also include a respective battery or other power source (not shown) configured to power the various components within the mobile robot 20. In one embodiment, the battery of the mobile robot 20 is a rechargeable battery configured to be charged when the mobile robot 20 is connected to the base station 46 that is configured for use with the mobile robot 20.

### Cloud Backend

FIG. 2B shows an exemplary embodiment of the cloud backend 50 that, in at least some embodiments, enables the improvements to performance and efficiency of a mobile robot 20 through lifelong learning. The cloud backend 50 comprises one or more cloud servers 52 and one or more cloud storage devices 62. The cloud servers 52 may include servers configured to serve a variety of functions for the cloud storage backend, including web servers or application servers depending on the features provided by the cloud backend 50, but at least include one or more database servers configured to manage mission data received from the mobile robot 20 and stored in the cloud storage devices 62. Each cloud servers 52 includes, for example, a processor 54, a memory 56, a user interface 58, and a network communications module 60. It will be appreciated that the illustrated embodiment of the cloud servers 52 is only one exemplary embodiment of a cloud server 52 and is merely representative of any of various manners or configurations of a personal computer, server, or any other data processing systems that are operative in the manner set forth herein.

The processor 54 is configured to execute instructions to operate the cloud server 52 to enable the features, functionality, characteristics and/or the like as described herein. To this end, the processor 54 is operably connected to the memory 56, the user interface 58, and the network communications module 60. The processor 54 generally comprises one or more processors which may operate in parallel or otherwise in concert with one another. It will be recognized by those of ordinary skill in the art that a “processor” includes any hardware system, hardware mechanism or hardware component that processes data, signals or other information. Accordingly, the processor 302 may include a system with a central processing unit, graphics processing units, multiple processing units, dedicated circuitry for achieving functionality, programmable logic, or other processing systems.

The cloud storage device 62 is configured to store mission data received from the mobile robot 20. The cloud storage device 62 may be of any type of long-term non-volatile storage device capable of storing information accessible by the processor 54, such as hard drives, solid-state drives, or any of various other computer-readable storage media recognized by those of ordinary skill in the art. Likewise, the memory 56 is configured to store program instructions that, when executed by the processor 54, enable the cloud server 52 to perform various operations described herein, including managing the mission data stored in the cloud storage devices 62. The memory 56 may be of any type of device or combination of devices capable of storing information accessible by the processor 302, such as memory cards, ROM, RAM, hard drives, discs, flash memory, or any of various other computer-readable media recognized by those of ordinary skill in the art.

The cloud server 52 may be operated locally or remotely by an administrator. To facilitate local operation, the cloud server 52 may include the user interface 58. In at least one embodiment, the user interface 58 may suitably include an LCD display screen or the like, a mouse or other pointing device, a keyboard or other keypad, speakers, and a microphone, as will be recognized by those of ordinary skill in the art. Alternatively, in some embodiments, an administrator may operate the cloud server 52 remotely from another computing device which is in communication therewith via the network communications module 60 and has an analogous user interface.

The network communications module 60 provides an interface that allows for communication with any of various devices, at least including the mobile robot 20 and the personal electronic device 70. In particular, the network communications module 60 may include a local area network port that allows for communication with any of various local computers housed in the same or nearby facility. Generally, the cloud server 52 communicates with remote computers over the Internet via a separate modem and/or router of the local area network. Alternatively, the network communications module 60 may further include a wide area network port that allows for communications over the Internet. In one embodiment, the network communications module 60 is equipped with a Wi-Fi transceiver or other wireless communications device. Accordingly, it will be appreciated that communications with the cloud server 52 may occur via wired communications or via the wireless communications. Communications may be accomplished using any of various known communications protocols.

The cloud server 52 is configured to store and manage a mission database for the mobile robot 20 in a secure way and to provide access to the mission database by the mobile robot 20 and by the personal electronic device 70. The mission database is stored on the cloud storage device 62 and may include mission data 64 received from the mobile robot 20, a copy of the environment map 34 that is used by the mobile robot 20, and one or more models 66 generated at least partially on the basis of the mission data 64. Additionally, the memory 56 stores program instructions of a lifelong learning program 68 for improving performance and efficiency of a mobile robot through lifelong learning, using the mission database stored on the cloud storage device 62.

### Personal Electronic Device

FIG. 2C shows an exemplary embodiment of personal electronic device 70. the personal electronic device 70 comprises a processor 72, a memory 74, a display screen 76, and at least one network communications module 78. The processor 72 is configured to execute instructions to operate the personal electronic device 70 to enable the features, functionality, characteristics and/or the like as described herein. To this end, the processor 72 is operably connected to the memory 74, the display screen 76, and the network communications module 78. The processor 72 generally comprises one or more processors which may operate in parallel or otherwise in concert with one another. It will be recognized by those of ordinary skill in the art that a “processor” includes any hardware system, hardware mechanism or hardware component that processes data, signals or other information. Accordingly, the processor 72 may include a system with a central processing unit, graphics processing units, multiple processing units, dedicated circuitry for achieving functionality, programmable logic, or other processing systems.

The memory 74 is configured to store data and program instructions that, when executed by the processor 72, enable the personal electronic device 70 to perform various operations described herein. The memory 74 may be of any type of device capable of storing information accessible by the processor 72, such as a memory card, ROM, RAM, hard drives, discs, flash memory, or any of various other computer-readable medium serving as data storage devices, as will be recognized by those of ordinary skill in the art. Among other things, the memory 74 stores a mobile robot application 80. As discussed in further detail below, the processor 72 is configured to execute program instructions of the mobile robot application 80 to operate and configure the mobile robot 20.

The display screen 76 may comprise any of various known types of displays, such as LCD or OLED screens. In some embodiments, the display screen 76 may comprise touch screens configured to receive touch inputs from a user. Alternatively, or in addition, the personal electronic device 70 may include additional user interfaces, such as buttons, switches, a keyboard or other keypad, speakers, and a microphone.

The network communications module 78 may comprise one or more transceivers, modems, processors, memories, oscillators, antennas, or other hardware conventionally included in a communications module to enable communications with various other devices, at least including the cloud backend 50 and/or the mobile robot 20. Particularly, the network communications module 78 generally includes a Wi-Fi module configured to enable communication with a Wi-Fi network and/or Wi-Fi router (not shown), as well as one or more cellular modems configured to communicate with wireless telephony networks. Additionally, the network communications module 78 may include a Bluetooth® module (not shown) configured to enable communication with the mobile robot 20.

The personal electronic device 70 may also include a respective battery or other power source (not shown) configured to power the various components within the personal electronic device 70. In one embodiment, the battery of the personal electronic device 70 is a rechargeable battery configured to be charged when the personal electronic device 70 is connected to a battery charger configured for use with the personal electronic device 70.

### Methods for Improving Performance and Efficiency of the Mobile Robot

A variety of methods and processes are described below for improving performance and efficiency of a mobile robot through lifelong learning. In these descriptions, statements that a method, processor, and/or system is performing some task or function refers to a controller or processor (e.g., the processor 54 of the cloud server 52) executing programmed instructions stored in non-transitory computer readable storage media (e.g., the memory 56 of the cloud server 52) operatively connected to the controller or processor to manipulate data or to operate one or more components in the cloud server 52 to perform the task or function. Additionally, the steps of the methods may be performed in any feasible chronological order, regardless of the order shown in the figures or the order in which the steps are described.

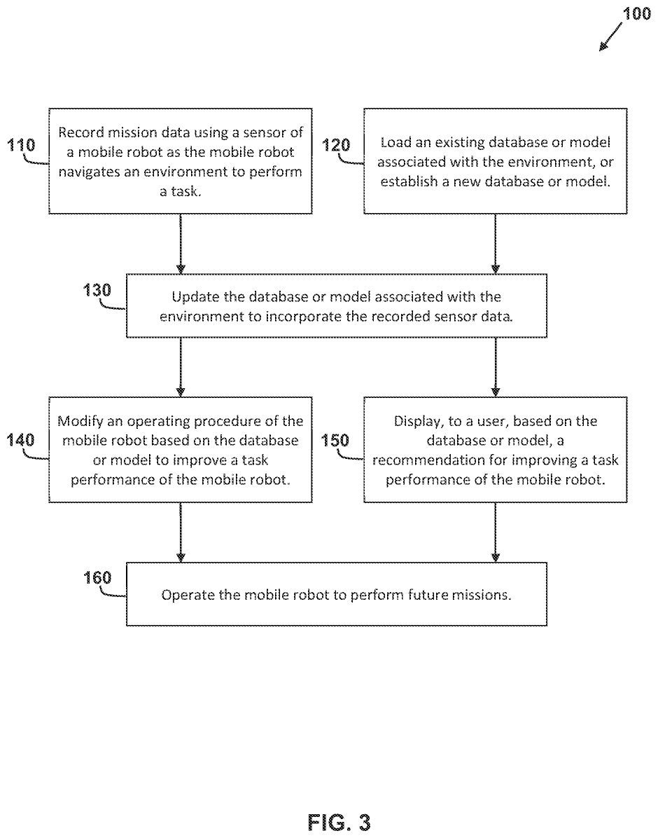

FIG. 3 shows flow diagram for a method 100 for improving performance and efficiency of a mobile robot that navigates an environment to perform a task. The method 100 advantageously leverages lifelong learning to continuously adapt to the particular environment 40 within which the mobile robot 20 is deployed and to improve its performance and efficiency in performing the task in the particular environment 40.

The method 100 begins with recording mission data using a sensor of a mobile robot as the mobile robot navigates an environment to perform a task (block 110). Particularly, the processor 22 of the mobile robot 20 executes instructions of the operating procedure 32 to operate the sensors 26 and actuators 28 to cause the mobile robot 20 to navigate the environment 40 and to perform the task. As discussed above, in at least some embodiments, the mobile robot 20 is, in particular, a robot vacuum or a robot mop and the task that is performed in the environment 40 is cleaning a floor surface in the environment 40. However, it should be appreciated by those of ordinary skill that methods described herein may be applicable to a wide variety of mobile robots that must autonomously navigate an environment to perform some task.

As the mobile robot 20 navigates the environment 40 to perform the task, the processor 22 receives a plurality of mission data from the sensors 26 and writes the mission data to the memory 24. In some embodiments, the processor 22 compresses the mission data prior to writing it to the memory 24. As used herein, the term “mission data” refers to any data recorded by the mobile robot 20 during performance of the task, at least including (1) raw sensor data from the sensors 26 of the mobile robot 20, (2) any data derived from the raw sensor data by processor 22 of the mobile robot 20, and (3) event data recorded by the mobile robot 20 describing events that occurred during the mission.

Raw sensor data may include, for example, RGB, IR, or RGB-D images captured by cameras of the mobile robot 20. Additionally, raw sensor data may include, for example, accelerations, rotational rates, and/or orientations measured by an accelerometer, gyroscope, or inertial measurement unit of the mobile robot 20. If a position sensor of some kind is provided in the mobile robot 20, then raw sensor data may include positions of the mobile robot 20 within the environment 40

Conversely, derived sensor data may also include positions of the mobile robot 20 within the environment 40 that are derived from the images, accelerations, rotational rates, and/or orientations, e.g., using visual and/or visual-inertial odometry methods such as simultaneous localization and mapping (SLAM). Additionally, derived sensor data may include times of flight and/or return times derived from light measurements captured by a light sensor of the mobile robot 20.

Finally, the event data includes data such as collision data identifying times at which the mobile robot 20 collided with something, stuck data identifying times at which the mobile robot 20 became stuck, and mission status data identifying times at which a mission started or ended or identifying whether the mission succeeded or failed. The event data may include data that is derived from the raw sensor data (e.g., detecting the events based on sensor data), as well as data that is simply logged by the operating procedure 32 of the mobile robot 20 (e.g., logging times or positions associated with a detected event).

Next, in at least some embodiments, the processor 22 operates the network communication module 30 to transmit the recorded mission data to the cloud server 52 of the cloud backend 50. The processor 54 of the cloud server 52 receives the recorded mission data via the network communication module 60 and writes the recorded mission data to the cloud storage device 62. In some embodiments, the processor 54 compresses the mission data prior to writing it to the cloud storage device 62. In at least one embodiment, the mobile robot 20 records the mission data throughout a mission and, after the mission is completed or otherwise terminated, the mobile robot 20 transmits the recorded mission data the cloud server 52 (e.g., when connected to the base station 46). However, in other embodiments, the mobile robot 20 may stream the recorded mission data to the cloud server 52 in real-time during the mission, or according to some other schedule.

The method 100 continues with loading an existing database or model associated with the environment, or establish a new database or model (block 120). Particularly, as will be discussed in greater detail below, the mission data is recorded by the mobile robot 20 over many missions within the same environment 40 and is stored in a database and/or used to generate and refine one or more models. This database and/or these model(s) will be used to improve a performance or efficiency of the mobile robot 20 in performing the task in the environment 40.

In the illustrated embodiments, the database and/or model(s) are stored on the cloud storage device 62 of the cloud backend (i.e., as mission data 64 and model(s) 66, shown in FIG. 2B). Throughout the description, the methods will be generally described with reference to this embodiment. However, it should be appreciated that, in some embodiments, the mission data 64 and the model(s) 66 are stored locally by the mobile robot 20 in the memory 24, and any processing of the mission data 64 and the model(s) 66 is performed locally by the processor 22 of the mobile robot 20.

After receiving the recorded mission data from the mobile robot 20, the processor 54 identifies mission data 64 and/or the model(s) 66 in the cloud storage device 62 associated with the respective mobile robot 20 and/or the respective environment 40, and prepares to update or revise the mission data 64 and/or the model(s) 66 based on the newly recorded mission data. In some embodiments, the processor 54 identifies the mission data 64 and/or the model(s) 66 associated with the respective mobile robot 20 and/or the respective environment 40 based on a user input (e.g., via a user interface of the personal electronic device 70).

Alternatively, if no mission data 64 or model(s) 66 exist in the cloud storage device 62 associated with the respective mobile robot 20 and/or the respective environment 40, the processor 54 generates a new database and/or one or more new model(s) 66 for the respective mobile robot 20. Likewise, if a user selects (e.g., via a user interface of the personal electronic device 70) to erase the existing mission data 64 or model(s) 66 associated with the respective mobile robot 20 and/or the respective environment 40, the processor 54 erases the existing mission data 64 or model(s) 66 associated with the respective mobile robot 20 and/or with the respective environment 40, and generates a new database and/or one or more new model(s) 66 for the respective mobile robot 20 and/or the respective environment 40.

In at least some embodiments, the mission data 64 captured by the mobile robot 20 is stored in the form of a database on the cloud storage device 62 (or the memory 24 of the mobile robot 20). The database may store the mission data of each type in a raw form or in a compressed form. For example, image data might be compressed prior to storage in the database, whereas event data might be stored in its raw form.

In some embodiments, at least some of the mission data 64 is stored in the form of a model that is configured to abstract the mission data such that it is easier for the mobile robot 20 to process or for users to understand. Any machine learning or statistical models can be adopted for this purpose, such as clustering (e.g., mean shift, k-means), function approximation (e.g., Gaussian mixture model, neural networks), or simple statistical analysis (e.g., mean and deviation, histogram).

In some embodiments, the model(s) 66 may comprise machine learning models such as convolution neural networks, recurrent neural networks, or the like. As used herein, the term “machine learning model” refers to a system or set of program instructions and/or data configured to implement an algorithm, process, or mathematical model (e.g., a neural network) that predicts or otherwise provides a desired output based on a given input. It will be appreciated that, in general, many or most parameters of a machine learning model are not explicitly programmed and the machine learning model is not, in the traditional sense, explicitly designed to follow particular programmatic rules in order to provide the desired output for a given input. Instead, a machine learning model is provided with a corpus of training data from which it identifies or “learns” implicit patterns and statistical relationships in the data, which are generalized to make predictions or otherwise provide outputs with respect to new data inputs. The result of the training process is embodied in a plurality of learned parameters, kernel weights, and/or filter values that are used in the various components of the machine learning model to perform various operations or functions.

To these ends, the processor 54 of the cloud server 52 (or the processor 22 of the mobile robot 20) trains or generates a model representing at least some of the mission data 64 received from the mobile robot 20. In some embodiments, the mission data used to train or generate a model is not permanently stored in the cloud storage device 62 (or in the memory 24 of the mobile robot 20), and instead is stored only temporarily to train or generate the model and then deleted. In at least some embodiments, the model(s) 66 are stored in the cloud storage device 62 (or in the memory 24 of the mobile robot 20) in the form of model parameters (e.g., model coefficients, machine learning model weights, etc.).

In some embodiments, a model is generated that summarizes one or more types of mission data. Particularly, in one embodiment, the processor 54 of the cloud server 52 (or the processor 22 of the mobile robot 20) trains or generates a model that indicates an attribute of the mission data. In one example, a model indicates a mathematical function that fits to and, thus estimates or summarizes, one or more types of mission data. In another example, a model indicates a frequency of a type of mission data with respect to one some classification, organizational, or categorization scheme (e.g., in the form of a histogram). In any case, the model not only enables a useful summarization of the mission data, but also reduces the storage requirement of the mission database.

In one embodiment, the processor 54 of the cloud server 52 (or the processor 22 of the mobile robot 20) trains or generates a model configured to receive a plurality of positions of the mobile robot 20 within the environment 40 corresponding to one or more missions and to output a relative proportion or amount of time spent while performing the task at various positions or regions within the environment 40 (i.e., a heatmap) and/or output particular positions or regions within the environment 40 that the mobile robot spends a most amount of time while performing the task (i.e., hotspots). Such a model may comprise, for example, a simple histogram model, a mean shift clustering model, a gaussian mixture model, or similar.

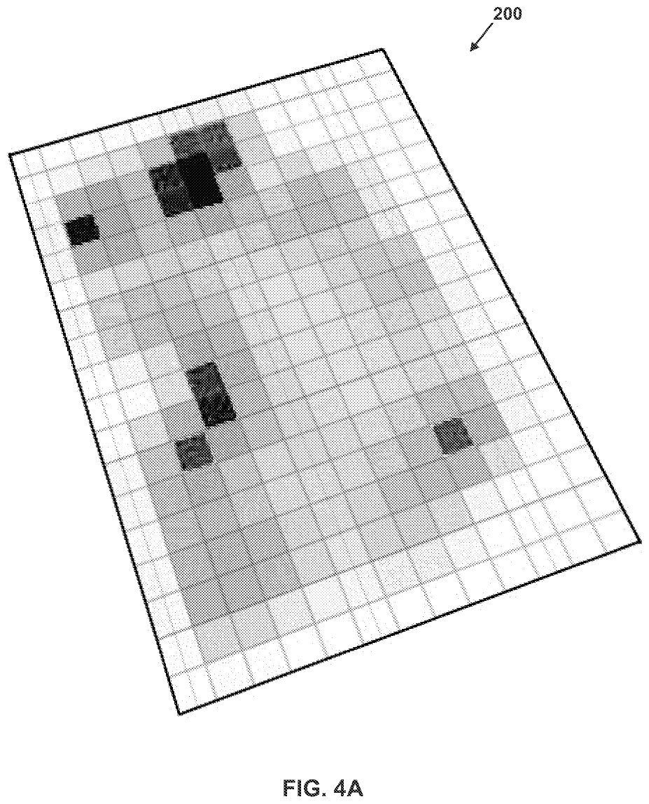

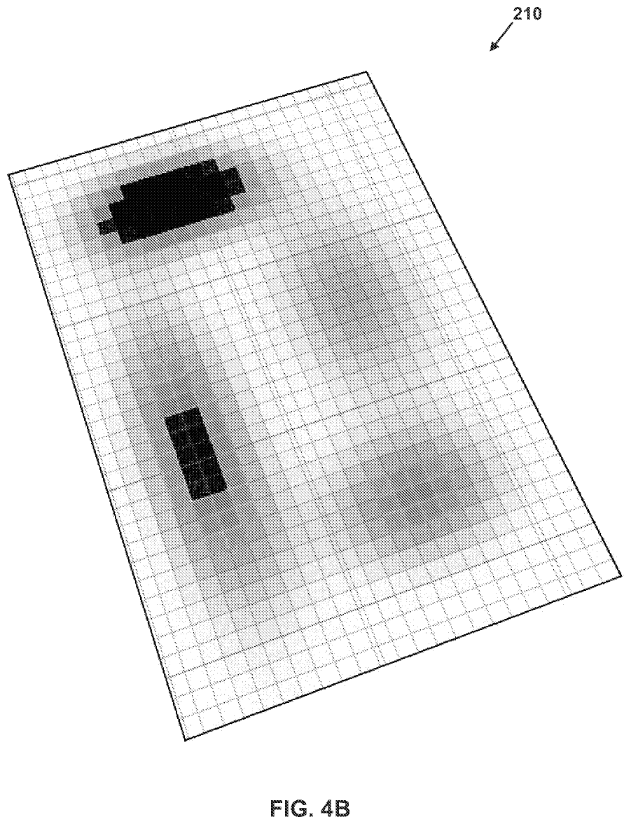

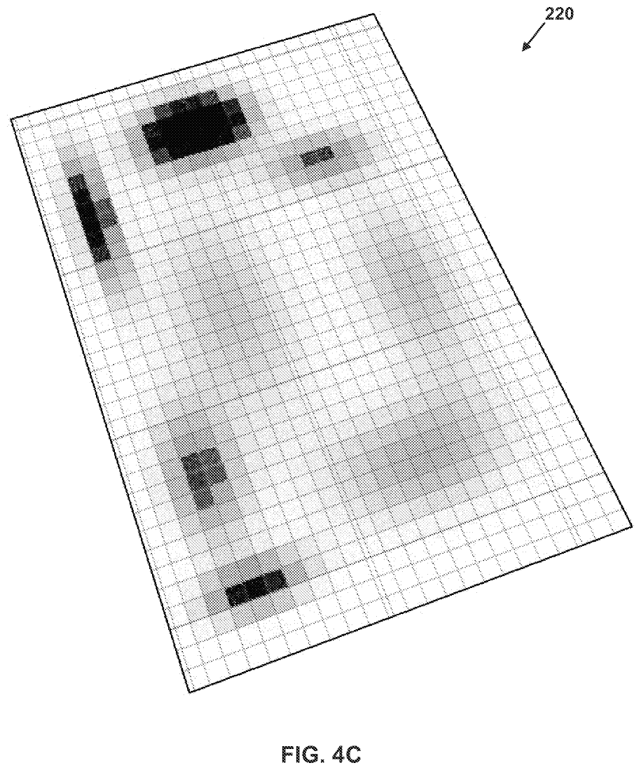

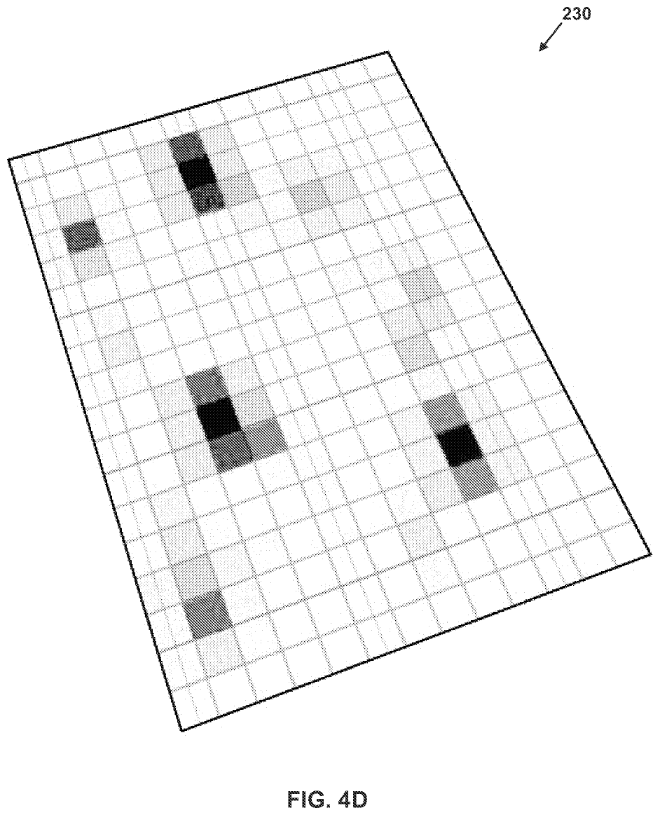

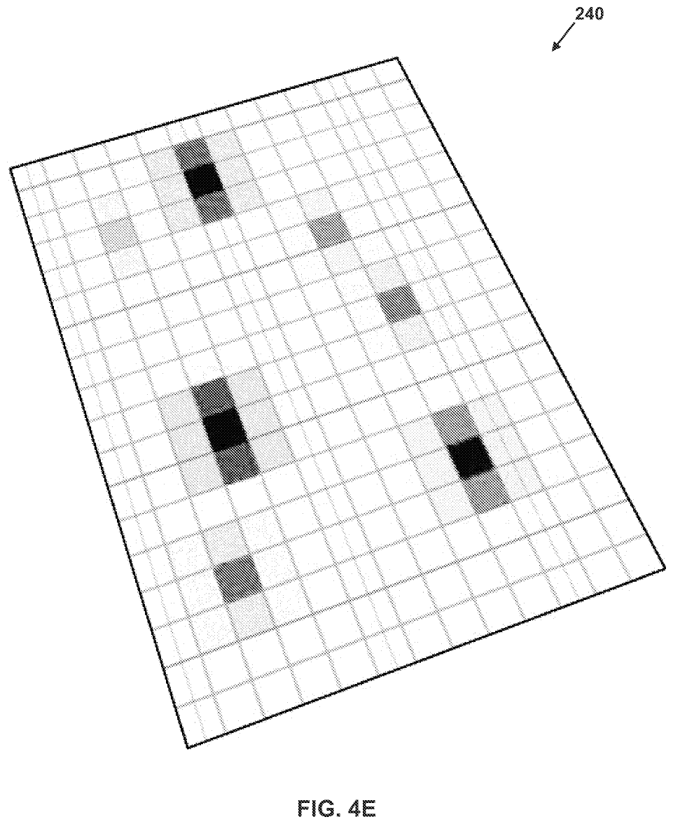

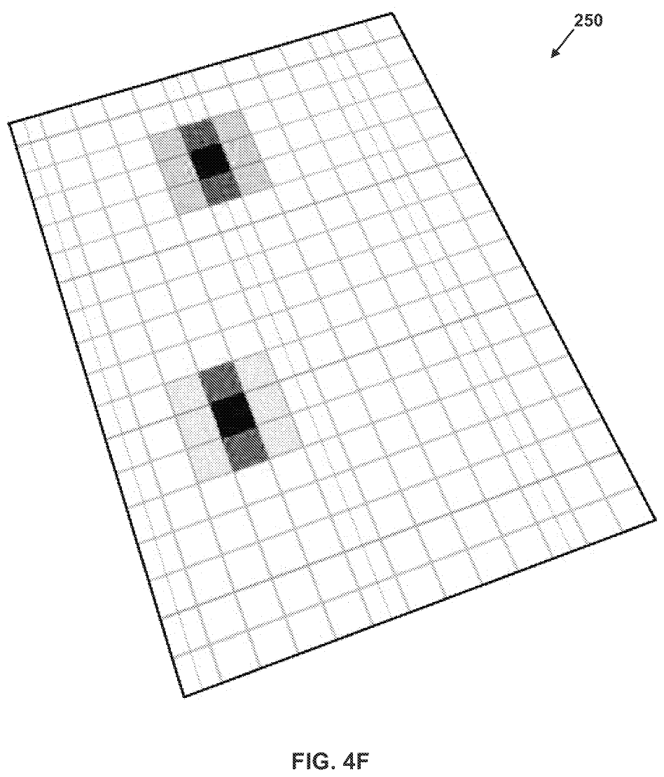

FIG. 4A shows a simple histogram model 200 that indicates a relative proportion or amount of time spent by the mobile robot 20 at various positions or regions within the environment 40 while performing the task. In the histogram model 200, darker shaded cells indicate regions within the environment 40 that the mobile robot 20 spends the most time, whereas lighter shaded cells indicate regions within the environment 40 that the mobile robot 20 spends relatively less time. In the illustration, the histogram model 200 includes a group of dark cells near the top that correspond the area around the base station 46 within the environment 40. Additionally, the histogram model 200 includes other smaller groups of dark cells that correspond generally to clutter 44 in the environment 40.

In some embodiments, other types of models can be similarly used to represent the position information. FIG. 4B shows a Gaussian mixture model 210 that similarly indicates a relative proportion or amount of time spent by the mobile robot 20 at various positions or regions within the environment 40 while performing the task. The Gaussian mixture model 210 is formed from four Gaussians. FIG. 4C shows a similar Gaussian mixture model 220 that is formed from eight Gaussians. FIG. 4D shows a mean shift clustering model 230 that similarly indicates a relative proportion or amount of time spent by the mobile robot 20 at various positions or regions within the environment 40 while performing the task. The mean shift clustering model 230 has a bandwidth of 0.1 meters. FIG. 4E shows a similar mean shift clustering model 240 having a bandwidth of 0.2 meters. FIG. 4F shows a similar mean shift clustering model 250 having a bandwidth of 0.4 meters.

In one embodiment, the processor 54 of the cloud server 52 (or the processor 22 of the mobile robot 20) trains or generates a model configured to receive a plurality of positions of the mobile robot 20 within the environment 40 corresponding to one or more missions from a particular base station location and output a distribution of mission time or travel distance from the respective base station location. Several such models may be determined with respect to several base station locations. In some embodiments, the position data of missions from different base station locations can be simulated, rather than received from the mobile robot 20. Such a model may comprise, for example, a simple histogram model, a mean shift clustering model, a gaussian mixture model, or similar.

In some embodiments, a model is generated that represents or predicts a relationship between two or more types of mission data. Particularly, in one embodiment, the processor 54 of the cloud server 52 (or the processor 22 of the mobile robot 20) trains or generates a model configured to receive a first type of mission data (e.g., raw sensor data) recorded by the mobile robot and output a prediction regarding a second type of mission data (e.g., event data). In this way, the model represents a relationship between the first type of mission data and the second type of mission data. However, the corresponding raw data itself of the first and second type received from the mobile robot 20 and used to train or generate the model need not be stored permanently. In this way, the model not only enables a predictive capability, but also reduces the storage requirement of the mission database.

In one embodiment, the processor 54 of the cloud server 52 (or the processor 22 of the mobile robot 20) trains or generates a model configured to predict a failure of the mobile robot 20 to complete the task based on particular sensor data (e.g., image data, accelerations, rotational rates, and/or orientations, position data, or times-of-flight data). In one particular example, the model receives images of the environment 40 captured by the mobile robot 20 and outputs a prediction as to whether the mobile robot 20 will fail to complete the task (e.g., images including certain objects might be predictive of failure). Such a model may, for example, comprise a neural network.

In another embodiment, the processor 54 of the cloud server 52 (or the processor 22 of the mobile robot 20) trains or generates a model configured to predict the mobile robot 20 getting stuck based on particular sensor data (e.g., image data, accelerations, rotational rates, and/or orientations, position data, or times-of-flight data). In one particular example, the model receives images of the environment 40 captured by the mobile robot 20 and outputs a prediction as to whether the mobile robot 20 will get stuck (e.g., images including certain objects might be predictive of getting stuck). Such a model may, for example, comprise a neural network.

Returning to FIG. 3, the method 100 continues with updating the database or model associated with the environment to incorporate the recorded sensor data (block 130). Particularly, as referenced above, the mission data recorded by the mobile robot 20 over many missions within the same environment 40 is stored in a database and/or used to generate and refine one or more models. Accordingly, as new mission data is recorded and received, the processor 54 of the cloud server 52 (or the processor 22 of the mobile robot 20) updates the mission data 64 and/or the model(s) 66 to incorporate the newly recorded mission data from the mobile robot 20.

In the case of the mission data 64 stored the form of a database, the processor 54 of the cloud server 52 (or the processor 22 of the mobile robot 20) adds the newly recorded mission data from the mobile robot 20 to the existing mission data already stored in the database, thereby creating combined mission data that incorporates both the newly recorded mission data and the existing previously recorded mission data from the mobile robot 20. In some embodiments, at least some of the existing data is compressed and the processor 54 of the cloud server 52 (or the processor 22 of the mobile robot 20) uncompresses the existing data prior to combining the newly recorded mission data with the existing data in the database. Once combined, the processor 54 of the cloud server 52 (or the processor 22 of the mobile robot 20) compresses the combined data, as appropriate.

In the case of the model(s) 66 representing at least some of the mission data received from the mobile robot 20, the processor 54 of the cloud server 52 (or the processor 22 of the mobile robot 20) refines the respective model(s) 66 using the newly recorded mission data as new training data or new source data. In at least some embodiments, during such a refinement process, the model parameters (e.g., model coefficients, machine learning model weights, etc.) of one or more of the model(s) 66 are modified or updated based on the newly recorded mission data. In this way, the model(s) 66 are revised to reflect the newly recorded mission data from the mobile robot 20, while retaining the previous learning based on the previously recorded mission data from the mobile robot 20.

The method 100 continues with modifying an operating procedure of the mobile robot based on the database or model to improve a task performance of the mobile robot (block 140). Particularly, the processor 54 of the cloud server 52 (or the processor 22 of the mobile robot 20) extracts useful information from the mission data 64 and/or the model(s) 66, which incorporate several missions worth of mission data collected by the mobile robot 20. The extracted information may include, for example, but is not limited to, mission completion times, distribution of robot position data, objects seen during the missions, position and velocity before failures, and image data before failures.

Based on the extracted information, the processor 54 of the cloud server 52 (or the processor 22 of the mobile robot 20) determines a modification to the operating procedure 32 of the mobile robot 20 that would improve the performance of the mobile robot 20 when performing the task in the environment 40. Improvement to the performance may include, for example, reducing a completion time of future missions (e.g., a robot vacuum or robot mop taking less time to clean the floor surface of the environment 40), providing a fully automated experience to the user, by not getting stuck and not needing manual intervention, increasing a quality metric of the performed task (e.g., a robot vacuum or robot mop achieving a greater degree of cleanliness after completing the task), or simply performing the task in a manner that is more satisfactory to the user in some respect (e.g., less annoying to the user).

Next, in some embodiments, the processor 54 of the cloud server 52 (or the processor 22 of the mobile robot 20) operates the network communication module 60 (or the network communication module 30) to transmit information describing the determined modification to the operating procedure 32 to the personal electronic device 70. The processor 72 receives the information describing the determined modification to the operating procedure 32 via the network communication module 78 and operates the display 78 to display, to the user, a recommendation including the modification to the operating procedure. In some embodiments, the processor 54 of the cloud server 52 (or the processor 22 of the mobile robot 20) further estimates and displays to the user a benefit of making the recommended modification to the operating procedure 32.

In response to receiving an input from the user approving the recommendation, the processor 72 operates the network communication module 78 to communicate this approval to the cloud server 52 (or to the mobile robot 20). In response to receiving the approval, the processor 54 of the cloud server 52 (or the processor 22 of the mobile robot 20) modifies the operating procedure 32 of the mobile robot 20 based on the determined modification to generate a modified operating procedure.

In alternative embodiments, the processor 54 of the cloud server 52 (or the processor 22 of the mobile robot 20) automatically modifies the operating procedure 32 of the mobile robot 20 based on the determined modification to generate a modified operating procedure, without approval from the user.

If the modified operating procedure is determined at the cloud backend 50, then the processor 54 of the cloud server 52 operates the network communication module 60 transmit the modified operating procedure to the mobile robot 20. The processor 22 of the mobile robot 20 receives the modified operating procedure from the cloud server 52 via the network communication module 30 and stores the modified operating procedure in the memory 24.

In a first example, based on the mission data 64 and/or the model(s) 66, a determined modification to the operating procedure 32 sets “no-go” zones within the environment 40 that should be avoided by the mobile robot 20 during future missions to improve its performance or efficiency. Particularly, if the mobile robot 20 tends to spend a long time at a particular location, one can infer that there may be a clutter around the location. The mobile robot 20 can reduce the mission time by either automatically setting a “no-go” zone or suggesting that the user to set a “no-go” zone.

To this end, the processor 54 of the cloud server 52 (or the processor 22 of the mobile robot 20) determines, based on the mission data 64 and/or the model(s) 66, a “no-go” zone within the environment 40 that the mobile robot 20 should not enter while performing the task in the environment (i.e., a “no-go” zone).

In at least one embodiment, the processor 54 of the cloud server 52 (or the processor 22 of the mobile robot 20) determines the “no-go” zone using a model 66 that identifies the relative proportion or amount of time spent while performing the task at various positions or regions within the environment 40 (i.e., a heatmap) and/or identifies particular positions or regions within the environment 40 that the mobile robot spends a most amount of time while performing the task (i.e., hotspots). These models may include, for example, statistical models (e.g., the histogram model 200), function approximation models (e.g., the Gaussian mixture models 210, 220), or clustering models (e.g., the mean shift clustering model 230, 240, 250).

In another embodiment, the processor 54 of the cloud server 52 (or the processor 22 of the mobile robot 20) determines the “no-go” zone using a model 66 that identifies positions or regions within the environment 40 associated with mission failure events or stuck robot events.

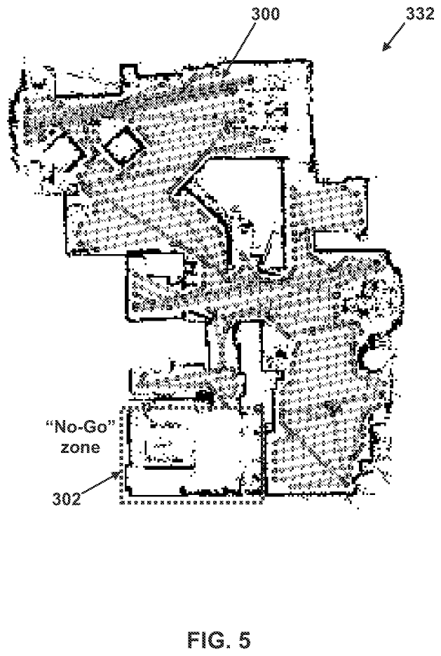

Alternatively, or in addition, the processor 54 of the cloud server 52 (or the processor 22 of the mobile robot 20) determines, based on the mission data 64 and/or the model(s) 66, a revised trajectory for performing the task in the environment 40 that would improve the performance of the mobile robot 20 when performing the task in the environment 40. The revised trajectory is determined based on the “no-go” zone and based on the environment map 32. In some embodiments, a quick (suboptimal) trajectory is determined locally by the processor 22 of the mobile robot 20 and, subsequently, a true optimal trajectory is determined by the processor 54 of the cloud server 50. FIG. 5 shows illustrates an exemplary revised trajectory 300 superimposed onto an environment map 332 that includes a “no-go” zone 302.

In a second example, based on the mission data 64 and/or the model(s) 66, a determined modification to the operating procedure 32 adjusts a trajectory planning or region prioritization such that certain problematic regions of within the environment 40 are visited last during future missions to improve its performance or efficiency. If the mobile robot 20 tends to spend a long time at a particular location, one can infer that there may be a clutter around the location. The mobile robot 20 can reduce the mission time by either automatically visiting the potential cluttered area later in the mission or suggesting to the user to that the potential cluttered area should be visited later in the mission.

To this end, the processor 54 of the cloud server 52 (or the processor 22 of the mobile robot 20) determines, based on the mission data 64 and/or the model(s) 66, a region within the environment 40 that the mobile robot 20 should enter later than other regions within the environment 40 when performing the task in the environment 40.

In at least one embodiment, the processor 54 of the cloud server 52 (or the processor 22 of the mobile robot 20) determines the region within the environment 40 that the mobile robot 20 should enter later than other regions within the environment 40 using a model 66 that identifies the relative proportion or amount of time spent while performing the task at various positions or regions within the environment 40 (i.e., a heatmap) and/or identifies particular positions or regions within the environment 40 that the mobile robot spends a most amount of time while performing the task (i.e., hotspots). These models may include, for example, statistical models (e.g., the histogram model 200), function approximation models (e.g., the Gaussian mixture models 210, 220), or clustering models (e.g., the mean shift clustering model 230, 240, 250).

Alternatively, or in addition, the processor 54 of the cloud server 52 (or the processor 22 of the mobile robot 20) determines, based on the mission data 64 and/or the model(s) 66, a revised trajectory for performing the task in the environment 40 that would improve the performance of the mobile robot 20 when performing the task in the environment 40. The revised trajectory is determined based on the previously determined region within the environment 40 that the mobile robot 20 should enter later than other regions within the environment 40 and based on the environment map 32. In some embodiments, a quick (suboptimal) trajectory is determined locally by the processor 22 of the mobile robot 20 and, subsequently, a true optimal trajectory is determined by the processor 54 of the cloud server 50.

In a third example, based on the mission data 64 and/or the model(s) 66, a determined modification to the operating procedure 32 identifies a problematic object and modifies the operating procedure 32 of the mobile robot 20 so that the mobile robot 20 avoids the object or similar objects during future missions to improve its performance or efficiency. Particularly, if failures often occur when an object with specific appearance is in the image, then the mobile robot 20 can avoid objects with similar appearance in future missions. This can be realized by self-supervised learning using both image and event (failure) data, where an inference model is trained to distinguish whether an object should be avoided or not.

To this end, the processor 54 of the cloud server 52 (or the processor 22 of the mobile robot 20) determines, based on the mission data 64 and/or the model(s) 66, an object in the environment 40 that should be avoided by the mobile robot 20 while performing the task in the environment 40.

In at least one embodiment, the processor 54 of the cloud server 52 (or the processor 22 of the mobile robot 20) determines the object in the environment 40 that should be avoided using a model 66 that receives images of the environment 40 (or other sensor data) captured by the mobile robot 20 and outputs a prediction as to whether the mobile robot 20 will fail to complete the task (e.g., images including certain objects might be predictive of failure). Such a model may, for example, comprise a neural network.

In another embodiment, the processor 54 of the cloud server 52 (or the processor 22 of the mobile robot 20) determines the object in the environment 40 that should be avoided using a model 66 receives images of the environment 40 (or other sensor data) captured by the mobile robot 20 and outputs a prediction as to whether the mobile robot 20 will get stuck (e.g., images including certain objects might be predictive of getting stuck). Such a model may, for example, comprise a neural network.

Returning to FIG. 3, the method 100 continues with displaying, to a user, based on the database or model, a recommendation for improving a task performance of the mobile robot (block 150). Particularly, the processor 54 of the cloud server 52 (or the processor 22 of the mobile robot 20) extracts useful information from the mission data 64 and/or the model(s) 66, which incorporate several missions worth of mission data collected by the mobile robot 20. The extracted information may include, for example, but is not limited to, mission completion times, distribution of robot position data, objects seen during the missions, position and velocity before failures, and image data before failures.

Based on the extracted information, the processor 54 of the cloud server 52 (or the processor 22 of the mobile robot 20) determines a recommended action that the user can take (e.g., with respect to the environment 40) that would improve the performance of the mobile robot 20 when performing the task in the environment 40.

In some embodiments, the processor 54 of the cloud server 52 (or the processor 22 of the mobile robot 20) operates the network communication module 60 (or the network communication module 30) to transmit information describing the recommended action that the user can take to the personal electronic device 70. The processor 72 receives the information describing the recommended action via the network communication module 78 and operates the display 78 to display, to the user, a recommendation including the recommended action. In some embodiments, the processor 54 of the cloud server 52 (or the processor 22 of the mobile robot 20) further estimates and displays to the user a benefit of taking the recommended action.

In a first example, based on the mission data 64 and/or the model(s) 66, a recommended action identifies an object within the environment 40 and recommends that the user remove the identified object from the environment 40 before performing future missions to improve the performance or efficiency of the mobile robot 20. Particularly, if the mobile robot 20 tends to spend a long time at a particular location, one can infer that there may be a clutter around the location. The mobile robot 20 can reduce the mission time by suggesting the user to remove a potential clutter.

To this end, the processor 54 of the cloud server 52 (or the processor 22 of the mobile robot 20) determines, based on the mission data 64 and/or the model(s) 66, an object in the environment 40 that should be removed from the environment 40. The processor 54 of the cloud server 52 (or the processor 22 of the mobile robot 20) operates the network communication module 60 (or the network communication module 30) to transmit information describing the object that should be removed from the environment 40 (e.g., a location within the environment or an image of the object) to the personal electronic device 70. The processor 72 receives the information describing the object via the network communication module 78 and operates the display 78 to display, to the user, a recommendation including the information describing the object that should be removed from the environment 40.

In one embodiment, the processor 54 of the cloud server 52 (or the processor 22 of the mobile robot 20) determines a location of the object that should be removed from the environment 40 using a model 66 that identifies the relative proportion or amount of time spent while performing the task at various positions or regions within the environment 40 (i.e., a heatmap) and/or identifies particular positions or regions within the environment 40 that the mobile robot spends a most amount of time while performing the task (i.e., hotspots). These models may include, for example, statistical models (e.g., the histogram model 200), function approximation models (e.g., the Gaussian mixture models 210, 220), or clustering models (e.g., the mean shift clustering model 230, 240, 250).

In another embodiment, the processor 54 of the cloud server 52 (or the processor 22 of the mobile robot 20) determines location of the object that should be removed from the environment 40 using a model 66 that identifies positions or regions within the environment 40 associated with mission failure events or stuck robot events.

In yet another embodiment, the processor 54 of the cloud server 52 (or the processor 22 of the mobile robot 20) determines the object that should be removed from the environment 40 using a model 66 that receives images of the environment 40 (or other sensor data) captured by the mobile robot 20 and outputs a prediction as to whether the mobile robot 20 will fail to complete the task (e.g., images including certain objects might be predictive of failure). Such a model may, for example, comprise a neural network.

In yet another embodiment, the processor 54 of the cloud server 52 (or the processor 22 of the mobile robot 20) determines the object that should be removed from the environment 40 using a model 66 receives images of the environment 40 (or other sensor data) captured by the mobile robot 20 and outputs a prediction as to whether the mobile robot 20 will get stuck (e.g., images including certain objects might be predictive of getting stuck). Such a model may, for example, comprise a neural network.

In a second example, based on the mission data 64 and/or the model(s) 66, a recommended action identifies a new location for a base station 46 for the mobile robot 20 and recommends that the user move the base station 46 to the new location to improve the performance or efficiency of the mobile robot 20. The new location may, for example, reduce an average travel time or distance required by the mobile robot 20 to perform the task in the environment 40.

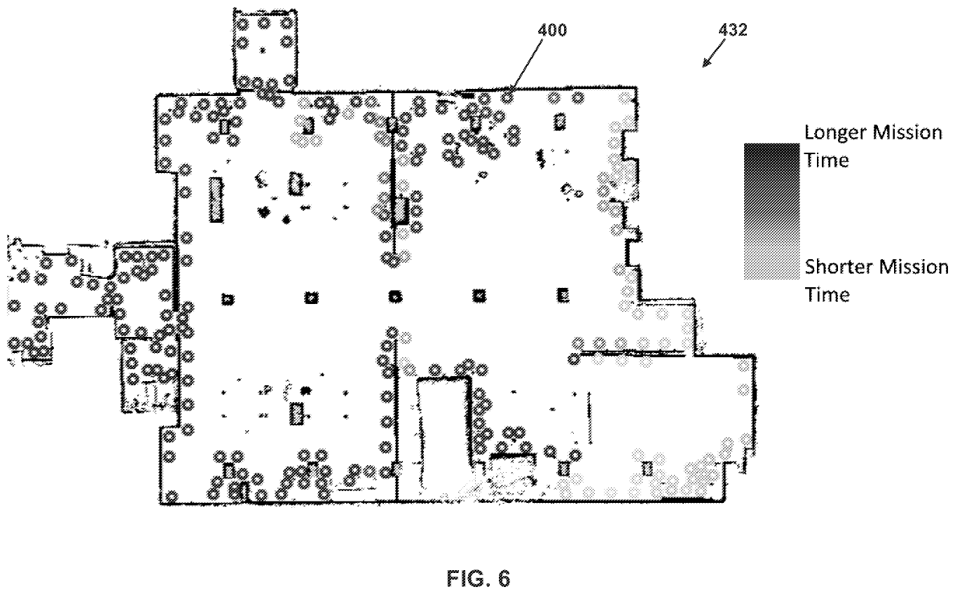

To this end, the processor 54 of the cloud server 52 (or the processor 22 of the mobile robot 20) determines, based on the mission data 64 and/or the model(s) 66, a recommended new location for a base station of the mobile robot 20 within the environment 40 that would improve the performance of the mobile robot when performing the task in the environment 40. FIG. 6 shows a plurality of possible base station locations 400 superimposed onto an environment map 332. In the illustration, the darker shaded possible base station locations 400 have a longer predicted mission time, whereas the lighter shaded possible base station locations 400 have a shorter predicted mission time

The processor 54 of the cloud server 52 (or the processor 22 of the mobile robot 20) operates the network communication module 60 (or the network communication module 30) to transmit information describing the new location for the base station to the personal electronic device 70. The processor 72 receives the information describing the new location via the network communication module 78 and operates the display 78 to display, to the user, a recommendation including the information describing the new location for the base station.

In one embodiment, the processor 54 of the cloud server 52 (or the processor 22 of the mobile robot 20) determines by comparing trajectories from different base (charging) station locations (either based on prior missions or simulated missions) and identifies a new location for the base station that likely results in shorter mission time or travel distance.

In yet another embodiment, the processor 54 of the cloud server 52 (or the processor 22 of the mobile robot 20) determines the new location for the base station using a model 66 that receives a plurality of positions of the mobile robot 20 within the environment 40 corresponding to one or more missions from a particular base station location and outputs a distribution of mission time or travel distance from the respective base station location. Such a model may comprise, for example, a simple histogram model, a mean shift clustering model, a gaussian mixture model, or similar.

The method 100 continues with operating the mobile robot to perform future missions (block 160). Particularly, as discussed above, if a modified operating procedure is generated, then it is provided to the mobile robot 20 and stored in the memory 24. In a future mission, the processor 22 of the mobile robot 20 executes instructions of the modified operating procedure 32 to operate the sensors 26 and actuators 28 to cause the mobile robot 20 to navigate the environment 40 and to perform the task. As with previously performed missions, as the mobile robot 20 navigates the environment 40 to perform the task, the processor 22 receives a plurality of mission data from the sensors 26 and writes the mission data to the memory 24. Next, in at least some embodiments, the processor 22 operates the network communication module 30 to transmit the recorded mission data to the cloud server 52 of the cloud backend 50.

Embodiments within the scope of the disclosure may also include non-transitory computer-readable storage media or machine-readable medium for carrying or having computer-executable instructions (also referred to as program instructions) or data structures stored thereon. Such non-transitory computer-readable storage media or machine-readable medium may be any available media that can be accessed by a general purpose or special purpose computer. By way of example, and not limitation, such non-transitory computer-readable storage media or machine-readable medium can comprise RAM, ROM, EEPROM, CD-ROM or other optical disk storage, magnetic disk storage or other magnetic storage devices, or any other medium which can be used to carry or store desired program code means in the form of computer-executable instructions or data structures. Combinations of the above should also be included within the scope of the non-transitory computer-readable storage media or machine-readable medium.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

While the disclosure has been illustrated and described in detail in the drawings and foregoing description, the same should be considered as illustrative and not restrictive in character. It is understood that only the preferred embodiments have been presented and that all changes, modifications and further applications that come within the spirit of the disclosure are desired to be protected.

What is claimed is:

1. A method for operating a mobile robot system, the mobile robot system including a mobile robot configured to perform a task in an environment using an operating procedure, the method comprising:
receiving first data that was recorded by the mobile robot at least in part using at least one sensor as the mobile robot navigates the environment to perform the task;
updating at least one of a database and a model associated with the environment to incorporate the first data; and
at least one of:
modifying the operating procedure, based on the at least one of the database and the model, to generate a modified operating procedure for performing the task in the environment that improves a performance of the mobile robot; and
determining, based on the at least one of the database and the model, and causing to be displayed to a user, a recommendation for improving the performance of the mobile robot when performing the task in the environment.

2. The method according to claim 1 further comprising:
providing the modified operating procedure to the mobile robot, the mobile robot being configured to perform the task in the environment again using the modified operating procedure.

3. The method according to claim 1, wherein the first data includes at least one of (i) position data indicate positions of the mobile robot in the environment while performing the task, (ii) images of the environment while performing the task, and (iii) event data indicating events that occur while performing the task.

4. The method according to claim 1, the updating the database further comprising:
adding the first data to the database, the database storing a plurality of second data that was recorded during a plurality of performances by the mobile robot of the task in the environment.

5. The method according to claim 4, the adding the first data to the database further comprising:
uncompressing the plurality of second data;
combining the first data with the uncompressed plurality of second data to generate combined data; and
compressing the combined data.

6. The method according to claim 1, the updating the model further comprising:
at least one of refining and training the model using the first data.

7. The method according to claim 6, wherein the model is configured to receive data recorded by the mobile robot and output a prediction regarding an event.

8. The method according to claim 7, wherein the model is configured to output a prediction regarding at least one of (i) a failure of the mobile robot to complete the task and (ii) the mobile robot getting stuck.

9. The method according to claim 6, wherein the model is configured to receive data recorded by the mobile robot and identify positions within the environment that the mobile robot spends a most amount of time while performing the task.

10. The method according to claim 1 further comprising:
determining, based on the at least one of the database and the model, a modification to the operating procedure that would improve the performance of the mobile robot when performing the task in the environment.

11. The method according to claim 10, the modifying the operating procedure further comprising:
automatically modifying the operating procedure to incorporate the modification, thereby generating the modified operating procedure.

12. The method according to claim 10, the causing to be displayed to the user the recommendation further comprising:
causing to be displayed, to the user, the recommendation including the modification to the operating procedure, the operating procedure being modified to incorporate the modification in response to receiving an input from the user approving the recommendation.

13. The method according to claim 10, the determining the modification further comprising:
determining, based on the at least one of the database and the model, a region within the environment that the mobile robot should not enter while performing the task in the environment.

14. The method according to claim 10, the determining the modification further comprising:
determining, based on the at least one of the database and the model, a region within the environment that the mobile robot should enter later than other regions within the environment when performing the task in the environment.

15. The method according to claim 10, the determining the modification further comprising:
determining, based on the at least one of the database and the model, an object in the environment that should be avoided by the mobile robot while performing the task in the environment.

16. The method according to claim 10, the determining the modification further comprising:
determining, based on the at least one of the database and the model, a revised trajectory for performing the task in the environment that would improve the performance of the mobile robot when performing the task in the environment.

17. The method according to claim 1, the causing to be displayed to the user the recommendation further comprising:
determining, based on the at least one of the database and the model, a recommended new location for a base station of the mobile robot within the environment that would improve the performance of the mobile robot when performing the task in the environment; and
causing to be displayed, to the user, the recommendation indicating the recommended new location for the base station.

18. The method according to claim 1, the causing to be displayed to the user the recommendation further comprising:
determining, based on the at least one of the database and the model, an object in the environment that should be removed from the environment; and
causing to be displayed, to the user, the recommendation indicating the object that should be removed from the environment.

19. A method for operating a mobile robot system, the mobile robot system including a mobile robot configured to perform a task in an environment using an operating procedure, the method comprising:
receiving first data that was recorded by the mobile robot at least in part using at least one sensor as the mobile robot navigates the environment to perform the task;
updating at least one of a database and a model associated with the environment to incorporate the first data;
modifying the operating procedure, based on the at least one of the database and the model, to generate a modified operating procedure for performing the task in the environment that improves a performance of the mobile robot; and
providing the modified operating procedure to the mobile robot, the mobile robot being configured to perform the task in the environment again using the modified operating procedure.

20. A method for operating a mobile robot system, the mobile robot system including a mobile robot configured to perform a task in an environment using an operating procedure, the method comprising:
receiving first data that was recorded by the mobile robot at least in part using at least one sensor as the mobile robot navigates the environment to perform the task;
updating at least one of a database and a model associated with the environment to incorporate the first data; and
determining, based on the at least one of the database and the model, and causing to be displayed to a user, a recommendation for improving a performance of the mobile robot when performing the task in the environment.
